(19) United States
(12) Patent Application Publication
(10) Pub. No.: US 2022/0203995 A1
(43) Pub. Date: Jun. 30, 2022

(54) DRIVER MANAGEMENT SYSTEM AND METHOD OF OPERATING SAME

(71) Applicant: HYUNDAI MOBIS CO., LTD., Seoul (KR)

(72) Inventors: Douglas C. MacKenzie, Livonia, MI (US); Brian Scott Moore, Potterville, MI (US)

(21) Appl. No.: 17/134,459

(22) Filed: Dec. 27, 2020

(51) Int. Cl. B60W 40/08; B60W 30/09; B60W 50/14

(52) U.S. Cl. CPC B60W 40/08; B60W 30/09; B60W 50/14; B60W 2540/229; B60W 2552/00; B60W 2420/54; B60W 2040/0827; B60W 2050/143; B60W 2420/42

(57) ABSTRACT

A driver management system and a method of operating the same. The driver management system includes: a monitoring part provided in a vehicle and determining a level of driving attention of a driver; and a vehicle stopping determination part receiving the level of driving attention of the driver, determining vehicle stop frequency at which a vehicle stops at a plurality of vehicle stopping points provided on a road, decreasing the vehicle stop frequency when the level of driving attention is high, and increasing the vehicle stop frequency when the level of driving attention is low.

### BACKGROUND OF THE INVENTION

### Field

Exemplary embodiments relate to driver management systems and methods of operating the same, in which a level of driving attention of a vehicle driver is determined, so as to determine vehicle stopping frequency at which a vehicle stops at a plurality of vehicle stopping points provided on a road according to the level of driving attention.

### Discussion of the Background

In driving a vehicle, a driver is obligated to drive the vehicle safely. While driving the vehicle, when the attention of the driver is decreased or the driver is drowsy, probability of a vehicle accident is increased and other vehicles in the vicinity are also threatened, resulting in an accident with nearby vehicles.

In particular, when driving various freight vehicles or trucks, often there are cases in which is drivers drive for a long time or long distances, and in such cases, the attention of the drivers is decreased or it is easy for the drivers to become drowsy.

Therefore, it is necessary to develop a system that guides a vehicle to a vehicle stopping point such as a weighing station or a rest area by monitoring a driver in order to prevent accidents when the attention of the driver is low or the driver is drowsy.

The above descriptions as background arts are only for improving the understanding of the background of the present invention, and should not be accepted as acknowledging that they correspond to the related arts already known to those skilled in the art.

### SUMMARY

Exemplary embodiments of the present invention solves this problem, and an objective of the present invention is to provide a driver management system and a method of operating the same, wherein a driver of a vehicle is monitored to determine a level of driving attention of the driver, and vehicle stopping frequency at which a vehicle stops at a plurality of vehicle stopping points provided on a road depending on the level of driving attention is determined, so that when the level of driving attention is low, the vehicle is guided to stop at the vehicle stopping points, thereby preventing accidents.

Additional features of the invention will be set forth in the description which follows, and in part will be apparent from the description, or may be learned by practice of the invention.

A driver management system according to the present invention for achieving the above objective includes: a monitoring part provided in a vehicle and determining a level of driving attention of a driver; and a vehicle stopping determination part receiving the level of driving attention of the driver, determining vehicle stop frequency at which the vehicle stops at a plurality of vehicle stopping points provided on a road, decreasing the vehicle stop frequency when the level of driving attention is high, and increasing the vehicle stop frequency when the level of driving attention is low.

The monitoring part may collect status information on a condition of the vehicle or the driver through a sensor provided in the vehicle, and may determine the level of driving attention of the driver through the status information.

The sensor may include a camera, a biometric sensor, a sound sensor, or a motion sensor, and may be operated toward the vehicle or the driver from a position inside or outside the vehicle.

The status information may include shaking of the vehicle, attention of the driver, or whether the driver is drowsy.

The monitoring part may determine that the level of driving attention of the driver is low, as a degree of the shaking of the vehicle increases or the attention of the driver is low, or when driver's drowsiness is detected, and may determine that the level of driving attention of the driver is high, as the degree of the shaking of the vehicle decreases or the attention of the driver is high, or when the driver's drowsiness is not detected.

The vehicle stopping determination part may be provided with a communication part, may communicate with the plurality of vehicle stopping points through the communication part, and may allow the level of driving attention to be transmitted to one of the nearest vehicle stopping points from the vehicle or to be informed to the driver or vehicle stopping points so as to stop the vehicle at corresponding vehicle stopping points when the level of driving attention of the driver is low.

A warning part may be provided in the vehicle, and the vehicle stopping determination part may warn the driver by operating the warning part when the level of driving attention of the driver is lower than a predetermined standard.

The warning part may warn the driver in a manner including a warning lamp, a warning light, or a warning sound inside the vehicle.

Each vehicle stopping point may include a weighing station, and the weighing station may measure weight of the vehicle when the vehicle stops.

The vehicle stopping determination part may decrease vehicle stopping frequency by guiding the driver so as to prevent the vehicle from stopping at the weighing station or to bypass the weighing station when the level of driving attention is high, and may increase the vehicle stopping frequency by guiding the driver to stop the vehicle at the weighing station when the level of driving attention is low.

A method of operating a driver management system according to the present invention for achieving the above objective includes: monitoring a level of driving attention of a driver, wherein the level of driving attention of the driver is determined; determining a vehicle stop, wherein vehicle stopping frequency at which a vehicle stops at a plurality of vehicle stopping points provided on a road is determined; and controlling the vehicle stop, wherein the vehicle stopping frequency is decreased when the level of driving attention determined in the monitoring of the level of driving attention of the driver is high, and the vehicle stopping frequency is increased when the level of driving attention is low.

The method of operating a driver management system may further include: warning the driver, wherein the driver may be warned when the level of driving attention of the driver is lower than a predetermined standard, after the controlling of the vehicle stop.

The method of operating a driver management system may further include: informing the driver or vehicle stopping points, wherein the level of driving attention may be allowed to be transmitted to one of the nearest vehicle stopping points from the vehicle or to be informed to the driver or vehicle stopping points so as to stop the vehicle at corresponding vehicle stopping points when the level of driving attention is low, after the controlling of the vehicle stop.

According to the driver management system and the method of operating the same of the present invention, a driver of a vehicle is monitored to determine a level of driving attention, and vehicle stopping frequency at which a vehicle stops at a plurality of vehicle stopping points provided on a road depending on the level of driving attention is determined, so that when the level of driving attention is low, the vehicle is guided to stop at the vehicle stopping points, thereby preventing accidents from occurring.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view showing a driver management system according to an exemplary embodiment of the present invention.

FIG. 2 is a view showing a vehicle passing through a plurality of vehicle stopping points in the driver management system according to the exemplary embodiment of the present invention.

FIG. 3 is a view showing a flowchart of a method of operating the driver management system according to the exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

As is customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

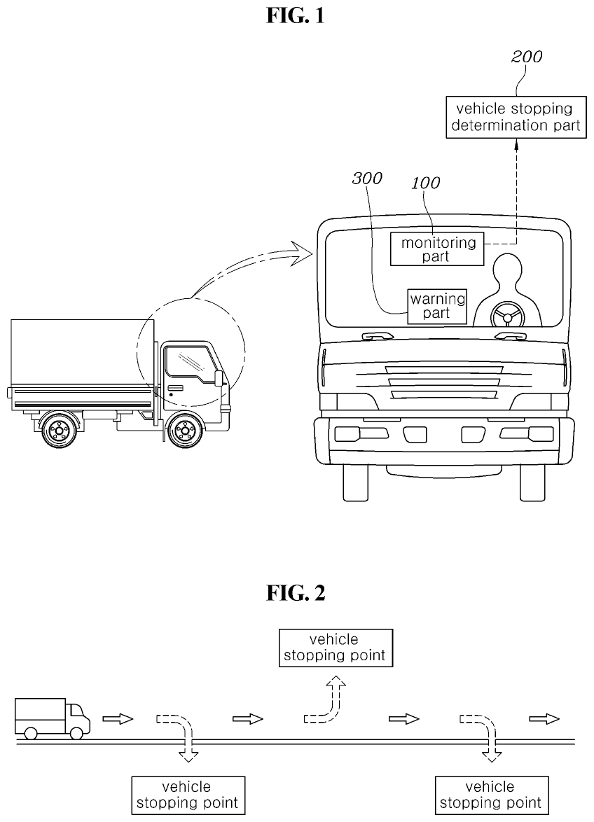

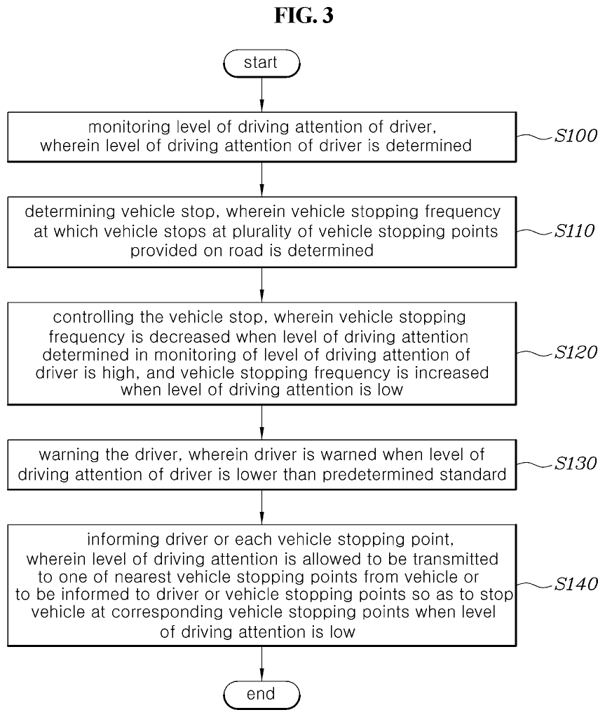

FIG. 1 is a view showing a driver management system according to an exemplary embodiment of the present invention. FIG. 2 is a view showing a vehicle passing through a plurality of vehicle stopping points in the driver management system according to the exemplary embodiment of the present invention. FIG. 3 is a view showing a flowchart of a method of operating the driver management system according to the exemplary embodiment of the present invention.

FIG. 1 is a view showing a driver management system according to the exemplary embodiment of the present invention The driver management system according to the exemplary embodiment of the present invention is provided in a vehicle, the driver management system including: a monitoring part 100 that determines a level of driving attention of a driver; and a vehicle stopping determination part 200 that receives the level of driving attention of the driver, determines vehicle stopping frequency at which the vehicle stops at the plurality of vehicle stopping points provided on a road, decreases the vehicle stopping frequency when the level of driving attention is high, and increases the vehicle stopping frequency when the level of driving attention is low. The vehicle stopping determination part 200 may be provided in a vehicle or may be provided in a server outside the vehicle.

Specifically, the monitoring part 100 determines a level of driving attention of a driver by monitoring the driver in a vehicle, and the level of driving attention may be classified into low risk, medium risk, high risk, etc. The vehicle stopping determination part 200, which has received the level of driving attention corresponding to the low risk, medium risk, high risk, etc. from the monitoring part 100, determines frequency or probability at which the driver stops the vehicle at vehicle stopping points according to the corresponding level of driving attention, so as to guide the driver to stop at the vehicle stopping points according to the vehicle stopping frequency or vehicle stopping probability. The vehicle stopping frequency or vehicle stopping probability increases as the level of driving attention decreases. Therefore, the driver who is drowsy driving or has less driving attention will be able to increase the level of driving attention, prevent accidents from occurring, and safely reach his or her destination by stopping more at vehicle stopping points than drivers who are not drowsy driving or have more driving attention.

Meanwhile, in the driver management system according to the exemplary embodiment of the present invention, the monitoring part 100 collects status information on a condition of a vehicle or a driver through a sensor provided in a vehicle, and may determine a level of driving attention of the driver through the status information. The status information may include shaking of the vehicle, attention of the driver, or whether the driver is drowsy. For example, the monitoring part 100 may use DDREM (Departed Driver Rescue and Exit Maneuver) technology in which a vehicle determines a condition of a driver to automatically move and stop the vehicle to a safe place such as a side road in a case where the driver is unable to drive normally, such as in the case of drowsy driving or cardiac arrest.

The DDREM technology provides a system, in which when a vehicle moves in zigzag due to drowsiness, etc., or a driver closes his or her eyes frequently without looking ahead, a sensor detects this condition and technically leads the vehicle to a safe place, thereby meaning to rescue the driver who is unable to drive. The DDREM technology uses two core technologies: a Driver Status Warning (DSW) system; and a Driver Awareness Warning (DAW) system, wherein the monitoring part 100 may determine a driver's condition such as the attention or whether the driver is drowsy driving by determining whether a driver's gaze is distracted, driver's blinking patterns, etc. through a sensor and the DSW system which are provided in a vehicle, and may determine a vehicle's condition such as whether the vehicle crosses lanes or the vehicle shakes, through the sensor and the DAW system. In this way, after collecting the status information on the condition of the vehicle or the driver, the monitoring part 100 determines a level of driving attention of the driver on the basis of the status information.

In addition, in the driver management system according to the exemplary embodiment of the present invention, a sensor includes a camera, a biometric sensor, a sound sensor, or a motion sensor, and may be operated toward a vehicle or a driver from a position inside or outside the vehicle. In the driver management system according to the exemplary embodiment of the present invention, the monitoring part 100 determines that the level of driving attention of the driver is low, as a degree of shaking of the vehicle increases or the attention of the driver is low, or when driver's drowsiness is detected, and may determine that the level of driving attention of the driver is high, as the degree of shaking of the vehicle decreases or the attention of the driver is high, or when the driver's drowsiness is not detected.

Specifically, in the driver management system according to the exemplary embodiment of the present invention, through a camera, a biometric sensor, a sound sensor, or a motion sensor, the monitoring part 100 monitors whether a driver is looking ahead or whether the driver is drowsy driving, and through the camera or motion sensor, the monitoring part 100 monitors whether a vehicle is driving while maintaining its lane or whether the vehicle shakes, whereby the level of driving attention of the driver may be determined according to the shaking of the vehicle, the attention of the driver, whether the driver is drowsy driving, etc.

Meanwhile, in the driver management system according to the exemplary embodiment of the present invention, the vehicle stopping determination part 200 is provided with a communication part, communicates with the plurality of vehicle stopping points through the communication part, and allows the level of driving attention to be transmitted to one of the nearest vehicle stopping points from the vehicle or to be informed to the driver or vehicle stopping points so as to stop the vehicle at corresponding vehicle stopping points when the level of driving attention of the driver is low. The vehicle stopping determination part 200 may be provided in a vehicle or in a server outside the vehicle, and communicates between the vehicle and the vehicle stopping points through the communication part, so as to stop the vehicle at the vehicle stopping points and guide the driver to allow the vehicle to enter the vehicle stopping points, depending on vehicle stopping frequency or vehicle stopping probability.

In addition, in the driver management system according to the exemplary embodiment of the present invention, a warning part 300 is provided in a vehicle, and the vehicle stopping determination part 200 may warn a driver by operating the warning part 300 when a level of driving attention of a driver is lower than a predetermined standard. The warning part 300 may warn the driver in a manner including a warning lamp, a warning light, or warning sound inside the vehicle. For example, when the level of driving attention determined by the monitoring part 100 is lower than the predetermined standard, which the level of driving attention being equal to or higher than the medium risk, that is, when the level of driving attention corresponds to medium or high risk, a warning lamp is turned on inside the vehicle, a warning light is controlled, or a warning sound is sent out, so that the level of driving attention of the driver may be increased and accidents may be prevented from occurring.

FIG. 2 is a view showing a vehicle passing through the plurality of vehicle stopping points in the driver management system according to the exemplary embodiment of the present invention. In the driver management system according to the exemplary embodiment of the present invention, each vehicle stopping point includes a weighing station, and the weighing station may measure weight of a vehicle when the vehicle stops. In the driver management system according to the exemplary embodiment of the present invention, the vehicle stopping determination part 200 decreases vehicle stopping frequency by guiding the driver to prevent the vehicle from stopping at the weighing station or to bypass the weighing station when the level of driving attention is high, and increases the vehicle stopping frequency by guiding the driver to stop the vehicle at the weighing station when the level of driving attention is low.

Specifically, in the case of a freight truck driver who drives a long distance, since the freight truck driver tends to drive a longer distance or for a longer time than a general driver, it is easy to lose attention or to drive drowsy while driving. In this case, the driver may increase the level of driving attention by stopping at a weighing station and taking a break. In particular, a freight truck requires regular weight measurement and inspection to see whether the freight truck has complied with cargo truck-related regulations, and there is a case where the freight truck is selected at random when passing through a weighing station on a general road, highway, etc., so that the weight measurement and inspection is conducted.

There is a system such as Drivewyze or PrePass that enables the driver to bypass such random selection. When these systems are linked with the driver management system according to the exemplary embodiment of the present invention, in a case where a level of driving attention is high, probability of bypassing a weighing station may be high until a freight truck is selected at the weighing station randomly, whereas in a case where a level of driving attention is low, the probability of bypassing the weighing station may be low until the freight truck is selected at the weighing station randomly. Therefore, when the level of driving attention is high, by increasing the probability of bypassing the weighing station, the vehicle stopping frequency or vehicle stopping probability at a plurality of weighing stations is decreased. Whereas, when the level of driving attention is low, by decreasing the probability of bypassing the weighing station, the vehicle stopping frequency or vehicle stopping probability at the plurality of weighing stations is increased.

Consequently, according to the level of driving attention determined by the monitoring part 100 and the vehicle stopping frequency determined by the vehicle stopping determination part 200, the driver stops at the plurality of vehicle stopping points such as the weighing stations, so that the driver with low level of driving attention increases the level of driving attention by way of receiving warnings from the warning part 300 and stopping frequently to take a break, thereby driving a vehicle safely and preventing accident from occurring, whereas a driver with high level of driving attention is allowed to have the decreased vehicle stopping frequency, thereby being able to drive to the destination safely and quickly.

FIG. 3 is a view showing a flowchart of a method of operating the driver management system according to the exemplary embodiment of the present invention. In a method of operating the driver management system according to the exemplary embodiment of the present invention, the method of operating the driver management system includes: a step S100 of monitoring a level of driving attention of a driver, wherein the level of driving attention of the driver is determined; a step S110 of determining a vehicle stop, wherein vehicle stopping frequency at which a vehicle stops at the plurality of vehicle stopping points provided on a road is determined; and a step S120 of controlling the vehicle stop, wherein the vehicle stopping frequency is decreased when the level of driving attention determined in the monitoring of the level of driving attention of the driver is high, and is increased when the level of driving attention is low.

In addition, after the controlling of the vehicle stop S120, a step S130 of warning the driver may be further included, wherein the driver is warned when the level of driving attention of the driver is lower than a predetermined standard.

Meanwhile, after the controlling of the vehicle stop S120, a step S140 of informing the driver or vehicle stopping points may be further included, wherein the level of driving attention is allowed to be transmitted to one of the nearest vehicle stopping point from the vehicle or to be informed to the driver or vehicle stopping points so as to stop the vehicle at corresponding vehicle stopping points when the level of driving attention is low.

Although a preferred embodiment of the present invention has been described for illustrative purposes, those skilled in the art will appreciate that various modifications, additions and substitutions are possible, without departing from the technical scope and spirit of the invention as disclosed in the accompanying claims.

What is claimed is:

1. A driver management system comprising:
a monitoring part provided in a vehicle and configured to determine a level of driving attention of a driver of the vehicle; and
a vehicle stopping determination part configured to receive the level of driving attention of the driver, and to determine a vehicle stop frequency at which the vehicle stops at a plurality of vehicle stopping points provided on a road,
wherein the vehicle stop frequency is decreased when the level of driving attention is determined to be high, and
wherein the vehicle stop frequency is increased when the level of driving attention is determined to be low.

2. The driver management system of claim 1, wherein the monitoring part is configured to collect status information on a condition of the vehicle or the driver via a sensor provided in the vehicle, and to determine the level of driving attention of the driver from the status information.

3. The driver management system of claim 2, wherein the sensor comprises a camera, a biometric sensor, a sound sensor, or a motion sensor, and is operated toward the vehicle or the driver from a position inside or outside the vehicle.

4. The driver management system of claim 2, wherein the status information comprises at least one of: a) vibration of the vehicle, b) attention of the driver, or c) whether the driver is drowsy.

5. The driver management system of claim 4, wherein the monitoring part is configured to determine that the level of driving attention of the driver is low as a result of a degree of the vibration of the vehicle increasing or the attention of the driver is determined to be low, or when driver's drowsiness is detected, and wherein the monitoring part is configured to determine that the level of driving attention of the driver is high as a result of the degree of the vibration of the vehicle decreasing or the attention of the driver is determined to be high, or when the driver's drowsiness is not detected.

6. The driver management system of claim 1, wherein the vehicle stopping determination part is provided with a communication part, which is configured to communicate with the plurality of vehicle stopping points through the communication part, and which is configured to allow the level of driving attention to be transmitted to one of the nearest vehicle stopping points from the vehicle or to be informed to the driver or vehicle stopping points so as to stop the vehicle at corresponding vehicle stopping points when the level of driving attention of the driver is determined to be low.

7. The driver management system of claim 1, wherein a warning part is provided in the vehicle, and the vehicle stopping determination part is configured to warn the driver by operating the warning part when the level of driving attention of the driver is determined to be lower than a predetermined level.

8. The driver management system of claim 7, wherein the warning part is configured to warn the driver in a manner including at least one of: a) a warning lamp, b) a warning light, or c) a warning sound inside the vehicle.

9. The driver management system of claim 1, wherein each vehicle stopping point includes a weighing station, and
the weighing station measures a weight of the vehicle when the vehicle stops.

10. The driver management system of claim 9, wherein the vehicle stopping determination part is configured to decrease a vehicle stopping frequency by guiding the driver so as to prevent the vehicle from stopping at the weighing station or to bypass the weighing station when the level of driving attention is determined to be high, and wherein the vehicle determination part is configured to increase the vehicle stopping frequency by guiding the driver to stop the vehicle at the weighing station when the level of driving attention is determined to be low.

11. A method of operating a driver management system, the method comprising:
determining a level of driving attention of a driver by monitoring the driver;
determining that a vehicle has stopped at a plurality of vehicle stopping points provided on a road,
based on the determining that the vehicle has stopped at the plurality of vehicle stopping points provided on the road, determining a vehicle stopping frequency at which the vehicle has stopped at the plurality of vehicle stopping points provided on the road; and
controlling a vehicle stop, such that the vehicle stopping frequency is decreased when the level of driving attention determined by the monitoring of the driver is high, and such that the vehicle stopping frequency is increased when the level of driving attention determined by the monitoring of the driver is low.

12. The method of claim 11, further comprising:
warning the driver, after the controlling of the vehicle stop, when the level of driving attention of the driver is determined to be lower than a predetermined level.

13. The method of claim 11, further comprising:
informing either the driver or vehicle stopping points, after the controlling of the vehicle stop, when the level of driving attention is determined to be low, by transmitting the level of driving attention to one of the nearest vehicle stopping points from the vehicle or by informing the driver that the level of driving attention is determined to be low.

14. The method of claim 11, wherein the monitoring of the driver comprises:
collecting, via a sensor provided in the vehicle, status information on a condition of the vehicle or the driver via a sensor provided in the vehicle, and
wherein the determining a level of driving attention comprises:
determining the level of driving attention of the driver based on the status information.

15. The method of claim 14, wherein the status information comprises at least one of: a) vibration of the vehicle, b) attention of the driver, or c) whether the driver is drowsy.

16. A non-transitory computer readable medium comprising program code that, when executed by at least one processor, cause the at least one processor to perform operations comprising:
determining a level of driving attention of a driver by monitoring the driver;
determining that a vehicle has stopped at a plurality of vehicle stopping points provided on a road,
based on the determining that the vehicle has stopped at the plurality of vehicle stopping points provided on the road, determining a vehicle stopping frequency at which the vehicle has stopped at the plurality of vehicle stopping points provided on the road; and
controlling a vehicle stop, such that the vehicle stopping frequency is decreased when the level of driving attention determined by the monitoring of the driver is high, and such that the vehicle stopping frequency is increased when the level of driving attention determined by the monitoring of the driver is low.

17. The non-transitory computer readable medium of claim 16, wherein the program code, when executed by the at least one processor, further causes the at least one processor to perform operations comprising:
warning the driver, after the controlling of the vehicle stop, when the level of driving attention of the driver is determined to be lower than a predetermined level.

18. The non-transitory computer readable medium of claim 16, wherein the program code, when executed by the at least one processor, further causes the at least one processor to perform operations comprising:
informing either the driver or vehicle stopping points, after the controlling of the vehicle stop, when the level of driving attention is determined to be low, by transmitting the level of driving attention to one of the nearest vehicle stopping points from the vehicle or by informing the driver that the level of driving attention is determined to be low.

19. The non-transitory computer readable medium of claim 16, wherein the monitoring of the driver comprises:
collecting, via a sensor provided in the vehicle, status information on a condition of the vehicle or the driver via a sensor provided in the vehicle, and
wherein the determining a level of driving attention comprises:
determining the level of driving attention of the driver based on the status information.

20. The non-transitory computer readable medium of claim 19, wherein the status information comprises at least one of: a) vibration of the vehicle, b) attention of the driver, or c) whether the driver is drowsy.
